(19) United States
(12) Patent Application Publication
(10) Pub. No.: US 2021/0179158 A1
(43) Pub. Date: Jun. 17, 2021

(54) ELECTRIC BOARD THAT CAN SWITCH BETWEEN AUTOMATIC AND MANUAL OPERATION

(71) Applicant: DCART Co., Ltd., Ansan-si (KR)

(72) Inventor: Byung Hak YUN, Yongin-si (KR)

(73) Assignee: DCART Co., Ltd., Ansan-si (KR)

(21) Appl. No.: 16/795,783

(22) Filed: Feb. 20, 2020

(30) Foreign Application Priority Data
Dec. 12, 2019 (KR) 10-2019-0165953

(51) Int. Cl. B62B 5/00; B62B 5/04; B62B 5/06; B62B 3/02; A63C 17/01; A63C 17/12

(52) U.S. Cl. CPC B62B 5/0059; B62B 5/004; B62B 5/0069; A63C 17/12; B62B 5/06; B62B 3/02; A63C 17/01; B62B 5/0438

(57) ABSTRACT

According to an example of the present disclosure, there is provided an electric board that can switch between automatic and manual operation including a frame configured to accommodate an occupant; a plurality of wheels moving the electric board; a plurality of motors respectively installed on the wheels; and a lever coupled directly to the motor and configured to manually cut off electric power applied to the motor through an operation of a user. When the electric power applied to an electronic brake provided in the motor is cut off by the lever, an operation of the electronic brake which controls a gearwheel of the motor by the electric power is stopped, and the electric board is configured to be converted into a state of being controlled by manual power of the user.

### CROSS-REFERENCE TO RELATED APPLICATION

This application claims priority to and the benefit of Korean Patent Application No. 10-2019-0165953 filed in the Korean Intellectual Property Office on Dec. 12, 2019, the entire contents of which are incorporated herein by reference.

### BACKGROUND OF THE INVENTION

### 1. Field of the Invention

The present disclosure relates to an electric board that can switch between automatic and manual operation. In detail, the present disclosure relates to an electric board configured to cut off or reapply electric power applied to an electronic brake through an operation of a lever.

### 2. Description of the Related Art

An electric board may mean a small vehicle driven by a motor while having a simple structure such as an electric wagon, an electric kickboard, an electric wheel, or an electric skateboard.

Therefore, it is difficult to operate the electric board only by manual power of a person while electricity is applied, and if the electric board needs to be moved only by manual power of a user while being driven, it may be troublesome to turn off a power source of the electric board.

### SUMMARY OF THE INVENTION

In order to solve the above problems, an object of the present disclosure is to provide a function of cutting off or applying electric power applied to an electronic brake built into a motor through a lever provided in the motor of an electric board. This allows a user to automatically or manually drive the electric board.

In an electric board that can switch between automatic and manual operation according to an example of the present disclosure to solve the technical problems described above, the electric board includes: a frame configured to accommodate an occupant; a plurality of wheels being coupled to a base plate and moving the electric board; a plurality of motors respectively installed on the wheels; and a lever coupled directly to the motor and configured to manually cut off electric power applied to the motor through an operation of a user. When the electric power applied to an electronic brake provided in the motor is cut off by the lever, an operation of the electronic brake which controls a gearwheel of the motor by the electric power is stopped, and the electric board is configured to be converted into a state of being controlled by manual power of the user.

In addition, the electric board may further include a base plate coupled to a lower end of the frame; and a bracket for connecting and fixing the wheels and the motors to the base plate.

In addition, the lever may extend to a predetermined length, may be formed to be parallel to the base plate, and may be operated by being tilted up and down.

In addition, the bracket may be configured of a first bracket for connecting the wheel to one side of a lower surface of the base plate and a second bracket for coupling the motor coupled to the wheel, to an inside of the lower surface of the base plate.

In addition, the lever may have a structure that avoids the bracket and a shaft fixing portion for fixing the first bracket and the wheel.

In addition, the lever may be configured by coupling a first extension portion extending to a predetermined length rearward the electric board, a vertical extension portion formed to a predetermined length in the other side of the first extension portion in a vertical direction to avoid the first bracket and the shaft fixing portion, and a second extension portion extending to a predetermined length at an end of the vertical extension portion rearward the electric board and being provided with a handle of the user.

In addition, the motor may be coupled to the wheel by the second bracket, a shaft of the motor may be provided with a gearwheel of a predetermined form, an inner ring of the wheel may be provided with an internal gear of a form corresponding to that of the gearwheel to couple the wheel in an in-wheel structure.

In addition, a battery groove having a predetermined size may be formed in one region of an upper surface or a lower surface of the base plate.

In addition, a battery of which a size corresponds to the size of the battery groove may be attached or detached to or from the battery groove, and the battery groove may have a structure to which the battery is attached, to apply electric power to the motor.

In addition, a locking member may be formed in one side surface of an inside of the battery groove to prevent the battery from being detached therefrom when the battery is coupled.

In addition, when the lever is formed to be coupled to any one of the base plate and the battery groove, the lever may be formed in a structure in which the electric power applied to the motor is cut off or supplied based on an operation of the user.

In addition, the frame may be configured of a rim-shaped first frame surrounding the occupant and a plurality of second frames provided in a side portion of the base plate and fixing the first frame to a predetermined height from an upper surface of the base plate.

In addition, the electric board may further include a canopy angle adjustment portion provided in a pair at a position of the first frame corresponding to a center position of the side surface of the electric board; and a canopy coupled to the canopy angle adjustment portion.

In addition, the canopy may be folded or unfolded by the canopy angle adjustment portion, and when the canopy is folded, the canopy may be flipped toward any one of a front portion or a rear portion of the first frame.

In addition, the canopy close to one side of the first frame may be formed to correspond to a shape of one side of the first frame based on the canopy angle adjustment portion.

In addition, the electric board may be any one of an electric wagon, an electric kickboard, an electric wheel, and an electric skateboard driven by a motor.

According to an example of the present disclosure, it is possible to implement a function of cutting off or applying the electric power applied to the electronic brake built into the motor through the lever provided in the motor of the electric board. Therefore, the user can operate the electric board automatically or manually.

### BRIEF DESCRIPTION OF THE DRAWINGS

FIG. 1A is a side view of an electric board that can switch between automatic and manual operation according to an example of the present disclosure.

FIG. 1B is a perspective view of the electric board that can switch between automatic and manual operation according to an example of the present disclosure.

FIG. 2 is a perspective view illustrating a bottom surface of a base plate according to an example of the present disclosure.

FIG. 3 is a bottom view of the base plate according to an example of the present disclosure.

FIG. 4 is a perspective view illustrating an upper surface of the base plate according to an example of the present disclosure.

FIG. 5A is a side view of the electric board for explaining a canopy according to an example of the present disclosure.

FIG. 5B is a side view of the electric board for explaining a canopy according to an example of the present disclosure.

FIG. 5C is a front view of a canopy angle adjustment device according to an example of the present disclosure.

### DETAILED DESCRIPTION OF THE EMBODIMENT

Hereinafter, examples of the present disclosure will be described in detail with reference to the accompanying drawings, so that those skilled in the art may easily implement the present disclosure. However, the present disclosure may be modified in various different forms and is not limited to the examples described here. In the drawings, portions irrelevant to the description are omitted in order to clearly describe the present disclosure, and like reference numerals designate like portions throughout the specification.

Throughout the specification, when a portion is “connected” to another portion, it includes not only “directly connected” but also “electrically connected” with another element interposed therebetween. In addition, when a portion is said to “include” a certain configuration element, which means that it may further include the certain configuration element, without excluding other configuration elements, unless specifically stated otherwise. It is to be understood that the present disclosure does not exclude a presence or a possibility of adding of one or more other features, numbers, steps, operations, configuration elements, partial components, or combinations thereof.

The following examples are detailed description to aid the understanding of the present disclosure, and do not limit the scope of the present disclosure. Therefore, the disclosure of a same scope performing a same function as that of the present disclosure will also fall within the scope of the present disclosure.

In addition, the ‘electric board’ referred to in the present specification may refer to any one of an electric wagon, an electric kickboard, an electric wheel, and an electric skateboard driven by a motor. Therefore, a shape and a detailed name of the electric board does not limit the scope of the present disclosure.

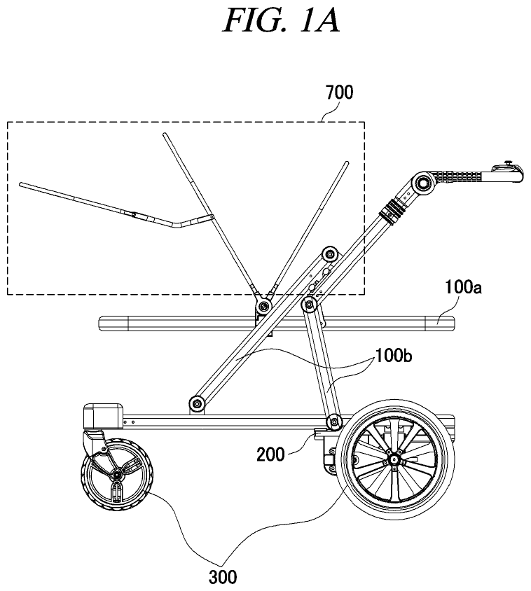

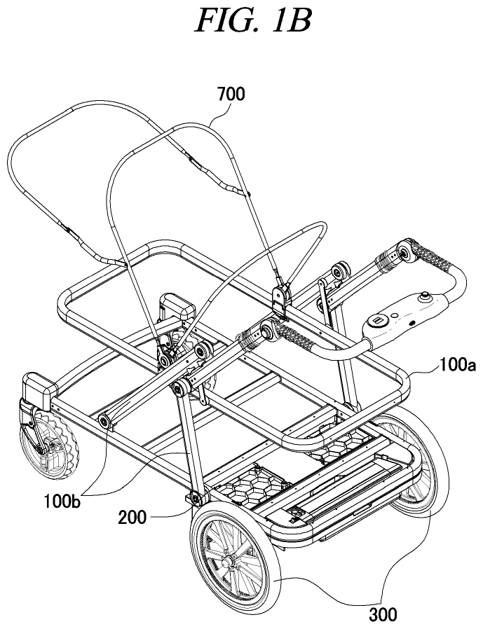

FIG. 1A is a side view of an electric board that can switch between automatic and manual operation according to an example of the present disclosure.

FIG. 1B is a perspective view of the electric board that can switch between automatic and manual operation according to an example of the present disclosure.

Referring to FIGS. 1A and 1B, the electric board may include a first frame 100a, second frames 100b, a base plate 200, wheels 300, and a canopy unit 700.

As described above, the ‘electric board’ refers to vehicle means driven by a motor, but for the sake of easy description of the present disclosure, the electric board referred to in the present specification will be described based on a shape of a stroller.

According to an example of the present disclosure, a lever is provided in the motor of the electric board, so that a user can cut off electric power applied to an electronic brake provided in the motor by operating the lever.

In this case, when the electric power is cut off by the lever, the electronic brake for controlling a gearwheel of the motor is stopped, and the electric board is switched to a state of being controlled by manual power of the user.

Therefore, in a case in which the lever is operated to a state in which the electric power is applied to the electronic brake, the electric board can be operated only by driving of the motor, and in this state, the user does not move the electric board even if the user pushes the electric board.

According to an example of the present disclosure, the frame may be configured in a form that can accommodate an occupant.

Therefore, the frame may be configured of the rim-shaped first frame 100a surrounding the occupant and a plurality of the second frames 100b provided in a side surface portion of the base plate 200 to fix the first frame 100a to a predetermined height from an upper surface of the base plate 200.

In this case, the first frame 100a and the second frame 100b may be provided with walls that serve as outer walls, and a seat on which the occupant is sitting may be further provided in an inside of the frame. If the base plate 200 has a form corresponding to a shape of a bottom surface of the electric board, the seat may be omitted.

In addition, in a case in which the electric board has a purpose other than the stroller and a shape corresponding thereto, accessories fitted thereto may be provided in the frame.

According to an example of the present disclosure, the base plate 200 is coupled to a lower end of the frame, and a battery, a motor, a control unit, and the like may be coupled thereto.

Therefore, the base plate 200 may have various shapes, that is, the base plate 200 may have a shape corresponding to the lower surface of the electric board or may be implemented in a shape corresponding to one region of the lower surface of the electric board to be coupled to the second frame 100b.

According to an example of the present disclosure, the wheel 300 may be coupled to the base plate 200 or the frame. In addition, one or a plurality of the wheels 300 may be provided in order to move the electric board.

Positions where the wheels 300 are provided may generally be both sides of the electric board, and some of the wheels 300 may be coupled to the motor to be rotated.

In this case, a size or a shape of the wheel 300 provided in the electric board can be applied in various ways depending on a structure of the electric board, and the plurality of the wheels 300 provided in the same electric board can also have different shapes or sizes as necessary. Therefore, in the present disclosure of the present application, the shape of the wheel 300 provided in the electric board does not limit the scope of the present disclosure.

According to an example of the present disclosure, the canopy unit 700 may be configured of a canopy frame and a blocking sheet (not illustrated) which is coupled to the canopy frame to cover an open upper portion of the electric board.

In this case, the blocking sheet of the canopy unit 700 may be made of a flexible material such as cloth, vinyl, or plastic, and maintains its shape through the frame.

In addition, the canopy unit 700 may have a structure that freely flips the canopy frame forward or rearward the electric board. By opening the upper portion of the electric board or unfolding the frame of the canopy unit 700 by driving a motor, it is possible to cover one region of the open upper portion of the electric board.

Although not illustrated in the drawings, as a further example, a control unit for driving the electric board may be fur provided. The control unit may be provided in a handle formed in the first frame 100a or may be provided in a separate wired/wireless controller to control the electric board.

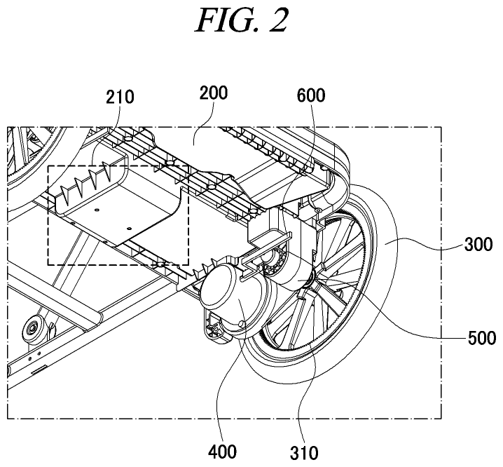

FIG. 2 is a perspective view illustrating a bottom surface of the base plate according to an example of the present disclosure.

Referring to FIG. 2, a battery groove 210, the wheel 300, an inner gearwheel 310, a motor 400, a bracket 500, and a lever 600 may be confirmed on the bottom surface of the base plate 200.

According to an example of the present disclosure, the battery groove 210 may be provided in a shape of a groove having a predetermined size in one region of the upper surface or the lower surface of the base plate.

In this case, when the battery is a detachable form, the battery groove 210 is formed to correspond to the shape of the detachable battery, and a position of the battery groove 210 may be formed in a region of the base plate 200 in which the user can be easily attach or detach the battery.

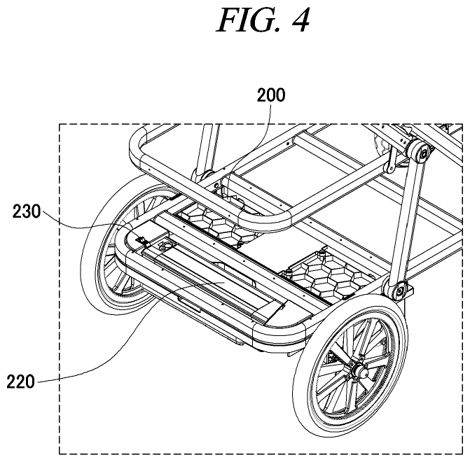

In this case, a configuration included in the battery groove 210 will be further described with reference to FIG. 4 which is described later.

According to an example of the present disclosure, the motor 400 is installed on each wheel 300, and rotates the coupled wheel 300 through the electric power applied from the battery.

According to an example of the present disclosure, the inner gearwheel 310 refers to a gearwheel in a shape of an internal gear formed on an inner ring of the wheel 300.

In this case, the motor 400 is coupled to the wheel 300 by the bracket 500, a shaft (not illustrated) of the motor 400 is provided with a predetermined gear wheel, to be coupled to the inner gearwheel 310.

Therefore, the inner gearwheel 310 is provided in a shape corresponding to that of the gearwheel provided in the motor 400, so that the motor 400 and the wheel 300 are coupled in an in-wheel structure.

According to an example of the present disclosure, the bracket 500 may serve to connect and fix the wheel 300 and the motor 400 to the base plate 200.

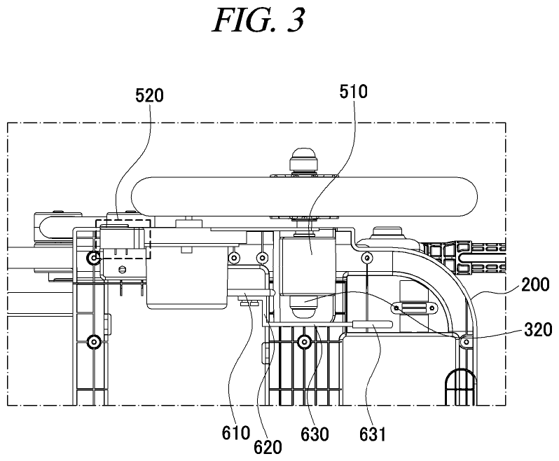

In this case, the bracket 500 serves to couple the wheel 300 and the motor 400 to the base plate 200, respectively, and the description of such a structure will be given with reference to FIG. 3 which is described later.

According to an example of the present disclosure, the lever 600 may be directly coupled to the motor 400 to manually cut off or reapply the electric power applied to the electronic brake of the motor 400 through an operation of the user.

In this case, the lever 600 may be configured to be extended to a predetermined length, formed to be parallel to the base plate 200, and operated by a method of being inclined up and down.

As described above, the user may cut off the electric power applied to the electronic brake according to an operation of the lever 600. In this case, if the electronic brake does not operate, the user can drive the electric board only by a force of the user for holding and pushing the frame or the handle of the electric board.

FIG. 3 is a bottom view of the base plate according to an example of the present disclosure.

Referring to FIG. 3, the bracket 500, the lever 600, and a wheel fixing portion 320 for fixing the bracket 500 and the wheel 300 can be confirmed in the bottom surface of the base plate 200.

According to an example of the present disclosure, the bracket 500 may be configured of a first bracket 510 for connecting the wheel 300 to one side of the lower surface of the base plate 200 and a second bracket 520 for coupling the motor 400 coupled to the motor 400, to an inside of the lower surface of the base plate 200.

In this case, the shaft fixing portion 320 may be provided to couple the wheel 300 to the first bracket 510, and to prevent the wheel 300 from being disassembled during rotation.

Therefore, the lever 600 may be formed in a structure that avoids the bracket 500 and the shaft fixing portion 320.

In this case, in order to have a structure that avoids the bracket 500 and the shaft fixing portion 320, the bracket 500 may be configured of a first extension portion 610, a vertical extension portion 620, and a second extension portion 630.

First, the first extension portion 610 may be provided in a shape in which one side thereof is coupled to the motor 400 and extends to a predetermined length rearward the electric board.

In addition, the vertical extension portion 620 is formed on the other side of the first extension portion 610 in a vertical direction and may be formed to have a predetermined length to avoid the first bracket 510 and the shaft fixing portion 320.

Finally, the second extension portion may be provided in a shape to extend to a predetermined length rearward the electric board at an end of the vertical extension portion 620.

In this case, the second extension portion may be provided with a handle 631, so that the user can grip the lever.

In a further example, the lever 600 is not provided in the shape of tilting up and down but the lever 600 may be provided in a shape of being pulled or pushed forward or rearward.

In a yet further example, in a case in which the lever 600 is not coupled to the motor 400 but is provided in another region of the electric board, the lever 600 may have a shape different from that described above. For example, in a case in which the lever 600 is provided in the control unit, the lever 600 is not in a shape of a lever but is provided in a shape of a button to cut off the electric power applied to the electronic brake of the motor 400.

FIG. 4 is a perspective view illustrating the top surface of the base plate according to an example of the present disclosure.

Referring to FIG. 4, a battery 220 coupled to the battery groove 210 and a locking member 230 for fixing the battery 220 may be formed on the upper surface of the base plate 200.

When the battery 220 may be implemented as a detachable battery so as to be mounted on the battery groove 210 and capable of being replaced with another battery by releasing the locking at an end of its life.

In addition, the locking member 230 may be formed on one side surface of the battery groove 210, and when the battery 220 is coupled, the locking member 230 may be formed in a structure to prevent the battery from being detached. For example, the locking member 230 may be provided in a form of a latch as illustrated in the drawing or may be provided in a form of a cover corresponding to the open surface of the battery groove 210.

Therefore, the form of the locking member 230 does not limit the scope of the present disclosure, and in a further example, in a case in which there is an electric charging structure, a separate charging cord may be further provided.

In addition, in a further example, the lever 600 described above may be coupled to the battery groove 210. Based on an operation of the lever 600, the electric power of the battery 220 coupled to the battery groove 210 can be cut off from being applied to the outside. This may be a method of electrically cutting off the application of the electric power to the battery 220 or may be a method of physically cutting off the electric power by inserting the lever 600 between the battery groove 210 and the battery 220. In such a case, the user can operate the electric board by manual power by directly cutting off the electric power applied to the motor 400, rather than cutting off the electric power applied to the electronic brake.

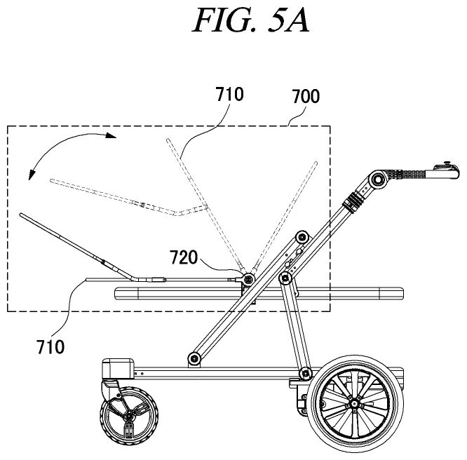

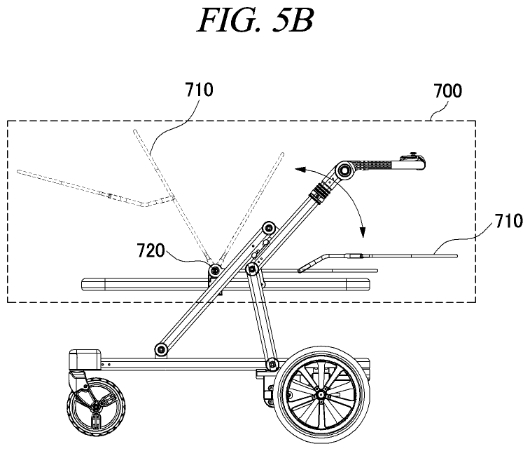

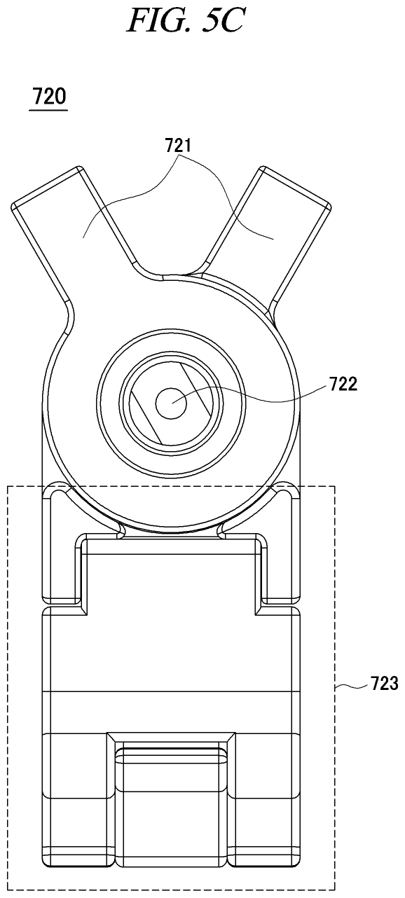

FIGS. 5A and 5B are side views of the electric board for explaining the canopy according to an example of the present disclosure.

Referring to FIGS. 5A and 5B, the canopy unit 700 may be constituted of a canopy frame 710 and a canopy angle adjustment portion 720.

First, the canopy angle adjustment portion 720 may be provided in a pair at a position of the first frame 100a corresponding to a center position of the side surface of the electric board.

In this case, the canopy frame 710 is coupled to the canopy angle adjustment portion 720, and the canopy unit 700 can be folded or unfolded through an operation of the canopy angle adjustment portion 720.

For example, the canopy frame 710 serves as a grate of a window, and when the canopy unit 700 is folded, the canopy frame 710 can be flipped in the forward direction (for example, FIG. 5A) or the rearward direction (for example, FIG. 5B) of the first frame 100a.

In this case, the flipped surface of the canopy frame 710 has a shape corresponding to the shape of one side of the first frame 100a. For example, when the canopy unit 700 is fully unfolded, a blocking sheet may be formed to cover one region of the first frame 100a based on the canopy angle adjustment portion 720. On the contrary, when the canopy unit 700 is folded and flipped back, the upper portion of the electric board is completely opened.

FIG. 5C is a front view of a canopy angle adjustment device according to an example of the present disclosure.

Referring to FIG. 5C, the canopy angle adjustment portion 720 may be configured of a first coupling portion 721, a rotation portion 722, and a second coupling portion 723.

According to an example of the present disclosure, the first coupling portion 721 can be coupled to the canopy frame 710.

In this case, the number of the first coupling portions 721 may be provided to correspond to the shape (number of frames serving as a grate of the blocking sheet) provided in the canopy frame 710.

In addition, one side of each of the plurality of first coupling portions 721 may be coupled through the rotation portion 722, and each canopy frame 710 can move about the rotation portion 722.

For example, in a case in which the angle between the two first coupling portions 721 illustrated in the drawing is minimized, the blocking sheet provided in the canopy unit 700 is folded. On the contrary, when the angle between the two first coupling portions 721 is maximized, the blocking sheet of the canopy unit 700 is fully unfolded. In addition, when the entire first coupling portions 721 are rotated in a clockwise direction by the rotation portion 722, the canopy performs light blocking in one direction. In addition, when the entire first coupling portions 721 are rotated in a counterclockwise direction, the canopy performs light blocking in a direction opposite to the one direction. In other words, in the present disclosure, the canopy is nut folded and unfolded in a state in which the position of the canopy is fixed at a position like a general stroller, but the canopy itself is allowed to be rotated left or right by the rotation portion 722 (see the positions of the canopy frame 710 of FIGS. 5a and 5b). In this case, when a child boarding on the electric board (or the electric wagon) is sitting in the left side, the canopy can be moved in the left direction to block the light, and when the child is sitting in the right side, the canopy can be moved in the opposite direction, that is, in the right direction to block the light.

In addition, the first coupling portion 721 positioned in any one of the left direction and right direction can be moved in the direction of the first frame 100a which is closest thereto. This allows the blocking sheet to freely fold or unfold forward or rearward the electric board.

For example, the first coupling portion 721 close to the front side of the electric board is flipped forward to be fixed and then the first coupling portion 721 close to the rear side is unfolded or folded, and thereby the blocking sheet can be formed in front of the electric board. On the other hand, in a case in which the two first coupling portions 721 are each unfolded to have a same angle from the first frame 100a, the blocking sheet may be formed at the center of the electric board.

Finally, the second coupling portion 723 may be used for coupling the canopy angle adjustment portion 720 to the first frame 100a.

Therefore, the canopy unit 700 is fixed to the electric board, and in a further example, the second coupling portion 723 is formed in a structure that is separated from the first frame 100a, so that the canopy unit 700 can also be separated from the electric board if necessary.

The foregoing description of the present disclosure is intended for illustration, and it will be understood by those skilled in the art that the present disclosure may be easily modified in other specific forms without changing the technical spirit or essential features of the present disclosure. Therefore, it should be understood that the examples described above are exemplary in all respects and not restrictive. For example, each configuration element described as a single type may be implemented in a separated manner, and similarly, configuration elements described as separated may be implemented in a coupled form.

The scope of the present disclosure is illustrated by the following claims rather than the above description, and all changes or modifications derived from the meaning and scope of the claims and their equivalents should be construed as being included in the scope of the present disclosure.

<Description of symbols>

| | |
|---|---|
| 100a: first frame | 100b: second frame |
| 200: base plate | 300: wheel |
| 400: motor | 500: bracket |
| 600: lever | 700: canopy unit |

What is claimed is:

1. An electric board configured to switch between automatic and manual operation, the electric board comprising:
a frame configured to accommodate an occupant;
a plurality of wheels moving the electric board;
a plurality of motors respectively installed on the wheels; and
a lever coupled directly to the motor and configured to manually cut off electric power applied to the motor through an operation of a user,
wherein when the electric power applied to an electronic brake provided in the motor is cut off by the lever, an operation of the electronic brake which controls a gearwheel of the motor by the electric power is stopped, and the electric board is configured to be converted into a state of being controlled by manual power of the user.

2. The electric board configured to switch between automatic and manual operation according to claim 1, further comprising:
a base plate coupled to a lower end of the frame; and
a bracket for connecting and fixing the wheels and the motors to the base plate.

3. The electric board configured to switch between automatic and manual operation according to claim 2, wherein the lever extends to a predetermined length, is formed to be parallel to the base plate, and is operated by being tilted up and down.

4. The electric board configured to switch between automatic and manual operation according to claim 2, wherein the bracket is configured of a first bracket for connecting the wheel to one side of a lower surface of the base plate and a second bracket for coupling the motor coupled to the wheel, to an inside of the lower surface of the base plate.

5. The electric board configured to switch between automatic and manual operation according to claim 4, wherein the lever has a structure that avoids the bracket and a shaft fixing portion for fixing the first bracket and the wheel.

6. The electric board configured to switch between automatic and manual operation according to claim 5, wherein the lever is configured by coupling a first extension portion extending to a predetermined length rearward the electric board, a vertical extension portion formed to a predetermined length in the other side of the first extension portion in a vertical direction to avoid the first bracket and the shaft fixing portion, and a second extension portion extending to a predetermined length at an end of the vertical extension portion rearward the electric board and being provided with a handle of the user.

7. The electric board configured to switch between automatic and manual operation according to claim 4, wherein the motor is coupled to the wheel by the second bracket, a shaft of the motor is provided with a gearwheel of a predetermined form, an inner ring of the wheel is provided with an internal gear of a form corresponding to that of the gearwheel to couple the wheel in an in-wheel structure.

8. The electric board configured to switch between automatic and manual operation according to claim 2, wherein a battery groove having a predetermined size is formed in one region of an upper surface or a lower surface of the base plate.

9. The electric board configured to switch between automatic and manual operation according to claim 8, wherein a battery of which a size corresponds to the size of the battery groove is attached or detached to or from the battery groove, and the battery groove has a structure to which the battery is attached, to apply electric power to the motor.

10. The electric board configured to switch between automatic and manual operation according to claim 9, wherein a locking member is formed in one side surface of an inside of the battery groove to prevent the battery from being detached therefrom when the battery is coupled.

11. The electric board configured to switch between automatic and manual operation according to claim 8, wherein, when the lever is formed to be coupled to any one of the base plate and the battery groove, the lever is formed in a structure in which electric power applied to the motor is cut off or supplied based on an operation of the user.

12. The electric board configured to switch between automatic and manual operation according to claim 2, wherein the frame is configured of a rim-shaped first frame surrounding the occupant and a plurality of second frames provided in a side portion of the base plate and fixing the first frame to a predetermined height from an upper surface of the base plate.

13. The electric board configured to switch between automatic and manual operation according to claim 12, further comprising:
a canopy angle adjustment portion provided in a pair at a position of the first frame corresponding to a center position of the side surface of the electric board; and
a canopy coupled to the canopy angle adjustment portion.

14. The electric board configured to switch between automatic and manual operation according to claim 13, wherein the canopy is folded or unfolded by the canopy angle adjustment portion, and when the canopy is folded, the canopy is flipped toward any one of a front portion or a rear portion of the first frame.

15. The electric board configured to switch between automatic and manual operation according to claim 14, wherein the canopy close to one side of the first frame is formed to correspond to a shape of one side of the first frame based on the canopy angle adjustment portion.

16. The electric board configured to switch between automatic and manual operation according to claim 1, wherein the electric board is any one of an electric wagon, an electric kickboard, an electric wheel, and an electric skateboard driven by a motor.
